(19) United States
(12) Patent Application Publication
(10) Pub. No.: US 2023/0377400 A1
(43) Pub. Date: Nov. 23, 2023

(54) DIGITAL-CURRENCY-BASED METHOD FOR VOTE COUNTING AND VOTE COUNTING SYSTEM

(71) Applicant: Old Cookies Co., Ltd., Taipei City (TW)

(72) Inventors: Shih-Chiun HONG, Taipei City (TW); Jih-Cherng Dennis CHEN, Taipei City (TW)

(21) Appl. No.: 17/663,680

(22) Filed: May 17, 2022

(51) Int. Cl. G07C 13/00; H04L 9/00; G06Q 20/38

(52) U.S. Cl. CPC G07C 13/00; H04L 9/50; G06Q 20/38

(57) ABSTRACT

A digital-currency-based method for vote counting includes a vote-counting procedure that includes steps of computing a number of newly-added votes based at least on an amount in a digital currency indicated by a piece of vote data, determining whether the piece of vote data was obtained during an ending portion, determining whether a voter identifier indicated by the piece of vote data has been recorded in at least a number N of data blocks when the piece of vote data was obtained during the ending portion, performing an adjustment procedure to adjust the number of newly-added votes when the voter identifier has been recorded in the number N of data blocks, reading a vote number, and computing a total number of votes based on the vote number and the number of newly-added votes.

### FIELD

The disclosure relates to vote counting, and more particularly to a digital-currency-based method and a vote counting system that utilize blockchain technology.

### BACKGROUND

A conventional electronic voting (also known as e-voting) method uses one or more computer devices to serve as a host for calculating and recording votes. Impartiality of such electronic voting method may be compromised by software and/or hardware failure related to the one or more computer devices, and also by malicious software.

### SUMMARY

Therefore, an object of the disclosure is to provide a digital-currency-based method for vote counting and a vote counting system that can alleviate at least one of the drawbacks of the prior art.

According to one aspect of the disclosure, the digital-currency-based method for vote counting is to be implemented by a vote counting system which includes multiple computer nodes in order to count, with respect to each of multiple candidates, a number of votes which are cast for the candidate during a voting period. The multiple computer nodes are in communication with one another and each include a storage module in which multiple storage regions corresponding respectively to the multiple candidates are allocated. Each of the storage regions stores at least one data block each of which is encrypted and records a currency amount, a vote number and a voter identifier, wherein one of the at least one data block that was last stored into the storage region serves as a latest data block in the storage region. The method includes a vote-counting procedure that is to be performed by one computer node of the multiple computer nodes when the one computer node obtains, during the voting period, a piece of vote data that indicates an amount in a digital currency, one candidate of the multiple candidates, and a voter identifier. The vote-counting procedure includes steps of: A) by the one computer node, computing a number of newly-added votes associated with the one candidate based at least on the amount in the digital currency that is indicated by the piece of vote data and a first weight that is associated with a date on which the piece of vote data was obtained; B) by the one computer node, determining whether the piece of vote data was obtained during an ending portion of the voting period; C) by the one computer node when it is determined that the piece of vote data was obtained during the ending portion, determining whether the voter identifier indicated by the piece of vote data has been recorded in at least a number N of data blocks stored in one storage region that corresponds to the one candidate among the storage regions of the one computer node, wherein N is a positive integer; D) by the one computer node when it is determined that the voter identifier has been recorded in at least the number N of data blocks, performing an adjustment procedure to adjust the number of newly-added votes; E) by the one computer node, reading, from the one storage region, the vote number recorded by the latest data block in the one storage region, and computing a total number of votes associated with the one candidate based on the vote number thus read and the number of newly-added votes, wherein when it is determined that the piece of vote data was obtained during the ending portion and when it is determined that the voter identifier has been recorded in at least the number N of data blocks, the number of newly-added votes adjusted in step D) is used to compute the total number of votes; F) by the one computer node after step E), generating a data block based at least on the amount in the digital currency and the voter identifier that are indicated by the piece of vote data and further on the total number of votes, wherein the data block thus generated includes currency amount information indicating a currency amount equal to the amount in the digital currency, vote number information indicating a vote number equal to the total number of votes, and the voter identifier; G) by the one computer node after step F), encrypting the data block thus generated, and storing the data block into the one storage region; and H) by the one computer node after step G), sending the data block thus encrypted to the other computer nodes of the multiple computer nodes of the vote counting system, so that each of the other computer nodes verifies the data block in response to receiving the data block, and stores the data block into one of the storage regions thereof that corresponds to the one candidate after successfully verifying the data block.

According to one aspect of the disclosure, the vote counting system is for counting, with respect to each of multiple candidates, a number of votes which are cast for the candidate during a voting period based on a digital currency and on a blockchain structure. The system includes multiple computer nodes that are in communication with one another through a communication network. Each of the computer nodes includes a communication module configured to connect with the communication network, a storage module, and a processor unit that is electrically connected to the communication module and the storage module. Multiple storage regions that correspond respectively to the multiple candidates are allocated in the storage module. Each of the storage regions stores at least one data block each of which is encrypted and records a currency amount, a vote number and a voter identifier, wherein one of the at least one data block that was last stored into the storage region serves as a latest data block in the storage region. The processor unit is configured to, when obtaining, during the voting period, a piece of vote data that indicates an amount in a digital currency, one candidate of the multiple candidates, and a voter identifier, compute a number of newly-added votes associated with the one candidate based at least on the amount in the digital currency that is indicated by the piece of vote data and a first weight that is associated with a date on which the piece of vote data was obtained. The processor unit is further configured to determine whether the piece of vote data was obtained during an ending portion of the voting period. The processor unit is further configured to, when it is determined that the piece of vote data was obtained during the ending portion, determining whether the voter identifier indicated by the piece of vote data has been recorded in at least a number N of data blocks stored in one storage region that corresponds to the one candidate among the storage regions of the computer node, wherein N is a positive integer. The processor unit is further configured to, when it is determined that the voter identifier has been recorded in at least the number N of data blocks, performing an adjustment procedure to adjust the number of newly-added votes. The processor unit is further configured to read, from the one storage region, the vote number recorded by the latest data block in the one storage region. The processor unit is further configured to compute a total number of votes associated with the one candidate based on the number of newly-added votes thus computed and the vote number thus read, wherein when it is determined that the piece of vote data was obtained during the ending portion and when it is determined that the voter identifier has been recorded in at least the number N of data blocks, the number of newly-added votes thus adjusted is used to compute the total number of votes. The processor unit is further configured to generate a data block based at least on the amount in the digital currency and the voter identifier that are indicated by the piece of vote data and further on the total number of votes thus computed, wherein the data block thus generated includes currency amount information indicating a currency amount equal to the amount in the digital currency, vote number information indicating a vote number equal to the total number of votes, and the voter identifier. The processor unit is further configured to encrypt the data block thus generated, and store the data block thus encrypted into the one storage region. The processor unit is further configured to send the data block thus encrypted to the other computer nodes of the multiple computer nodes of the vote counting system, so that each of the other computer nodes verifies the data block in response to receiving the data block, and stores the data block into one of the storage regions thereof that corresponds to the one candidate after successfully verifying the data block.

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram that exemplarily illustrates a vote counting system according to an embodiment of the disclosure;

FIG. 2 is a block diagram that exemplarily illustrates data stored in storage regions according to an embodiment of the disclosure;

FIG. 3 is a flow chart that exemplarily illustrates a vote-counting procedure according to an embodiment of the disclosure;

FIG. 4 is a flow chart that exemplarily illustrates a first adjustment procedure according to an embodiment of the disclosure;

FIG. 5 is a flow chart that exemplarily illustrates a second adjustment procedure according to an embodiment of the disclosure; and

FIG. 6 is a flow chart that exemplarily illustrates a vote-inquiry procedure according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

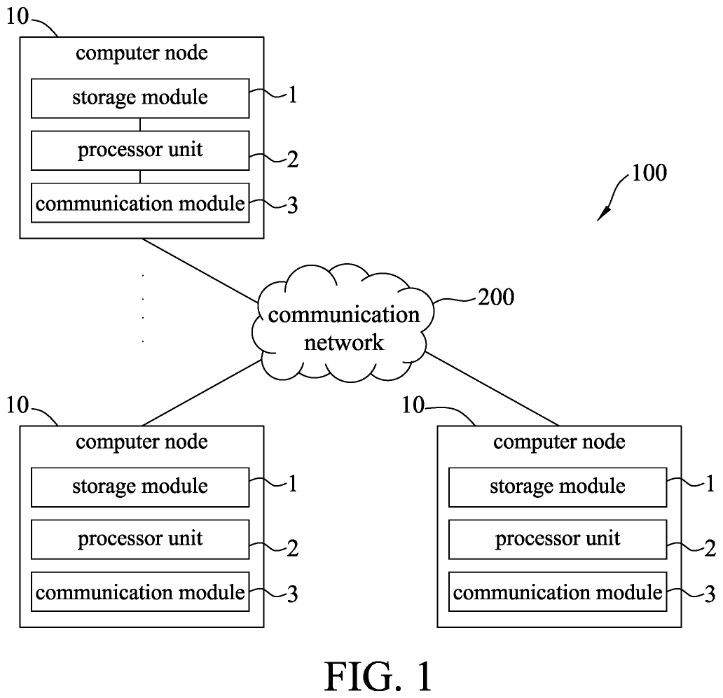

FIG. 1 exemplarily illustrates a vote counting system 100 according to an embodiment of the disclosure. The vote counting system 100 is configured to count, with respect to each of multiple candidates, a number of votes which are cast for the candidate during a voting period based on a digital currency and on a blockchain structure. According to some embodiments of the disclosure, the digital currency may be Ether or another cryptocurrency, but the disclosure is not limited thereto. For example, the digital currency may be another kind of virtual currency or token. The vote may relate to any subject. For example, in some embodiments, the vote may be a certain title such as “most popular Internet star” in which case the candidates may be real or virtual persons contending for the title, or the vote may relate to a public issue in which case the candidates are different policies directed to the public issue, or the vote may involve choosing a product under a specific category from among multiple products, but the disclosure is not limited thereto.

Referring to FIG. 1, the system 100 includes multiple computer nodes 10 that are in communication with one another through a communication network 200. According to some embodiments, the computer nodes 10 may each be a computing device such as a personal computer (PC), a notebook, a tablet computer or a smart phone, and the communication network 200 may be the Internet or Ethernet, but the disclosure is not limited thereto. It is noted that the number of computer nodes 10 illustrated in FIG. 1 is only exemplary. That is, in different embodiments, the system 100 may include more or less than three computer nodes 10.

Each of the computer nodes 10 includes a storage module 1, a communication module 3 and a processor unit 2 electrically connected to the storage module 1 and the communication module 3. The communication module 3 is configured to connect with the communication network 200, so that the computer node 10 may send/receive data to/from other computer nodes 10 through the communication network 200. Although not shown in FIG. 1, each of the computer nodes 10 may further include a display. In an embodiment where the computer node 10 is a PC, the storage module 1 is a computer memory, the processor unit 2 is a central processing unit (CPU), and the communication module 3 is a network interface controller (NIC), but the disclosure is not limited thereto.

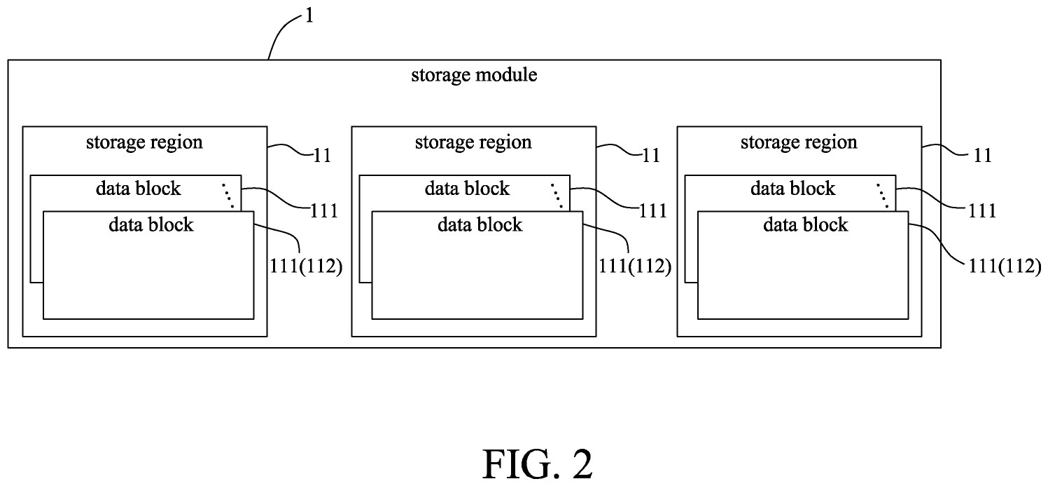

Further referring to FIG. 2, multiple storage regions 11 that correspond respectively to the multiple candidates are allocated in the storage module 1 of each computer node 10. Each of the storage regions 11 stores at least one data block 111 that is encrypted, wherein one of the at least one data block 111 that was last stored into the storage region 11 serves as a latest data block 112 in the storage region 11. Each of the data block(s) 111 records a currency amount, a vote number and a voter identifier. In an embodiment, a first data block 111 that records a vote number equal to zero is pre-stored in each of the storage regions 11. The vote number of the latest data block 112 in the storage region 11 is indicative of a total number of votes that have been cast for the candidate that corresponds to the storage region 11.

According to some embodiments, the storage regions 11 may respectively be different memory spaces allocated in the storage module 1. It is noted that the number of storage regions 11 illustrated in FIG. 2 is only exemplary. Although in the embodiment illustrated in FIG. 2, three storage regions 11 that correspond respectively to three candidates are included in the storage module 1, the storage module 1 may include more or less than three storage regions 11 that correspond respectively to more or less than three candidates in different embodiments.

The system 100 is adapted to perform a digital-currency-based method for vote counting that includes a vote-counting procedure, an adjustment procedure and a vote-inquiry procedure.

The vote-counting procedure is to be performed by any of the computer nodes 10 when the computer node 10 obtains a piece of vote data during the voting period. According to some embodiments, the computer node 10 may obtain the piece of vote data by generating the piece of vote data in response to an input by a user (i.e., voter) to the computer node 10, or by receiving the piece of vote data through the communication network 200 from a user terminal that is another computing device (e.g., a smart phone) operated by the user and that has access to the communication network 200. The piece of vote data indicates an amount in a digital currency (hereinafter referred to as “digital currency amount”), a voter identifier associated with the user, and one candidate (also referred to as “target candidate” hereinafter) of the multiple candidates.

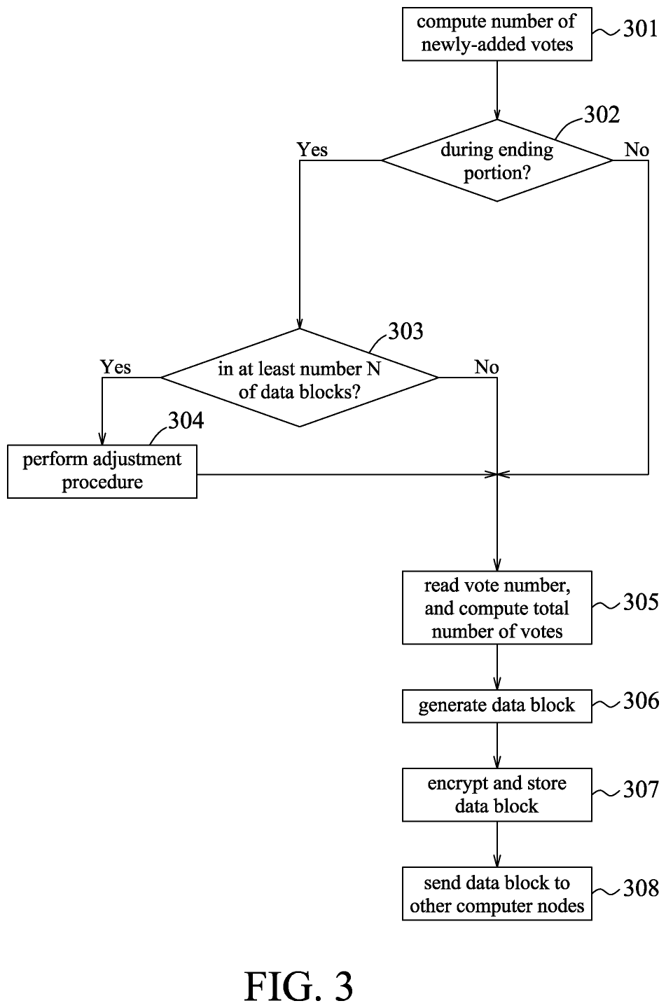

Referring to FIG. 3, the vote-counting procedure includes Steps 301-308.

In Step 301, the processor unit 2 of the computer node 10 computes a number of newly-added votes associated with the target candidate based at least on the digital currency amount that is indicated by the piece of vote data and a first weight that is associated with a date (i.e., voting date) on which the piece of vote data was obtained. In some embodiments, the first weight is positively correlated with a number of days (also referred to as “remaining days”) from the date on which the piece of vote data was obtained till a deadline of the voting period. For example, in an embodiment where forty Ethers may be exchanged for one vote and where the first weight is a product of the number of remaining days and 0.1, when the piece of vote data indicates eight hundred Ethers and was obtained four days before the deadline, eight newly-added votes may be calculated based on an equation of

$$\frac{800}{40} \times ( 0.1 \times 4 ) = 8.$$

In some embodiments, the piece of vote data further indicates an influence attribute related to the voter, and the number of newly-added votes is computed further based on a second weight that is associated with the influence attribute, so that the number of newly-added votes is positively correlated with a rank that is related to the influence attribute. For example, in some embodiments, the influence attribute may be either a first type which is “the average person” with a rank of level one and corresponding to the second weight equal to one, or a second type which is “an expert” with a rank of level two and corresponding to the second weight equal to two. In one of such embodiments where ten Bitcoins may be exchanged for one vote and where the first weight is a product of the number of remaining days and 0.1, when the piece of vote data indicates one hundred Bitcoins and the influence attribute of the second type, and was obtained three days before the deadline, six newly-added votes may be computed based on an equation of

$$\frac{100}{10} \times ( 0.1 \times 3 ) \times 2 = 6.$$

In Step 302, the processor unit 2 of the computer node 10 determines whether the piece of vote data was obtained during an ending portion of the voting period. If so, the process goes to Step 303; otherwise, the process goes to Step 305. According to some embodiments, the ending portion may be a few days or several hours before the deadline of the voting period, but the disclosure is not limited thereto.

In Step 303, the processor unit 2 of the computer node 10 determines whether the voter identifier indicated by the piece of vote data has been recorded in at least a number N of data blocks stored in one storage region 11 that corresponds to the target candidate (also referred to as “matching storage region”) among the storage regions 11 of the one computer node 10. If so, the process goes to Step 304; otherwise, the process goes to Step 305. N is a positive integer. According to some embodiments, N may be an integer less than or equal to five. By determining whether the voter identifier has been recorded in at least the number N of data blocks, suspicious votes may be detected. Step 304 is performed when a suspicious vote is detected.

In Step 304, the processor unit 2 of the computer node 10 performs the adjustment procedure to adjust the number of newly-added votes, so that impact to the fairness that is caused by the suspicious vote may be suppressed. Details of the adjustment procedure will be described later.

In Step 305, the processor unit 2 of the computer node 10 reads, from the matching storage region 11, the vote number (referred to as “original vote number” hereinafter) recorded by the latest data block in the matching storage region 11, and computes a total number of votes associated with the target candidate based on the vote number thus read and the number of newly-added votes. It is noted that when Step 305 is performed after performing Step 304 (that is, when the piece of vote data was obtained during the ending portion and when the voter identifier indicated by the piece of vote data has been recorded in at least the number N of data blocks), the number of newly-added votes would have already been adjusted in Step 304; otherwise, the number of newly-added votes used in Step 305 would be that computed in Step 301. In some embodiments, the total number of votes is computed as a sum of the original vote number and the number of newly-added votes.

In Step 306, the processor unit 2 of the computer node 10 generates a data block 111 based at least on the digital currency amount and the voter identifier that are indicated by the piece of vote data and further on the total number of votes. The data block 111 thus generated includes currency amount information indicating a currency amount equal to the digital currency amount, vote number information indicating a vote number equal to the total number of votes, and the voter identifier. According to some embodiments, the data block 111 may be generated further based on the date (i.e., the voting date) on which the piece of vote data was obtained and a time point at which the piece of vote data was obtained, and the data block thus generated may further include date and time information that is indicative of when the piece of vote data was obtained.

In Step 307, the processor unit 2 of the computer node 10 encrypts the data block 111 thus generated, and stores the data block 111 thus encrypted into the matching storage region 11 to serve as the latest data block 112 in the matching storage region 11. According to some embodiments, the data block 111 maybe encrypted by using existing blockchain encryption technology such as hashing, public key infrastructure (PKI) encryption or the unspent transaction output (UTXO) model.

In Step 308, the processor unit 2 of the computer node 10 sends the data block 111 thus encrypted to the other computer nodes 10 of the vote counting system 100, so that each of the other computer nodes 10, in response to receiving the data block 111, verifies the data block 111 by decrypting the data block 111 using an existing blockchain decryption technology that corresponds to the encryption technology used in Step 307, and stores the data block 111 into one of its own storage regions 11 that corresponds to the target candidate (to serve as the latest data block 112) after successfully verifying the data block 111. In this way, the data block 111 is synchronously stored in each of the computer nodes 10, so that data coherency across all of the computer nodes 10 is maintained.

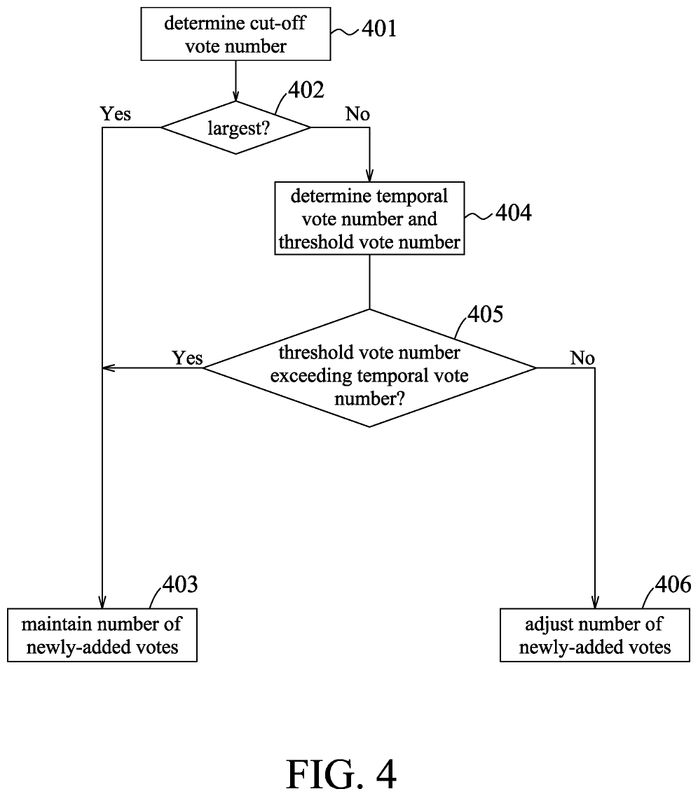

Various adjustment procedures may be performed in Step 304 of the vote-counting procedure. FIG. 4 exemplarily illustrates a first adjustment procedure that may be performed in Step 304 according to an embodiment of the disclosure. Referring to FIG. 4, the first adjustment procedure includes Steps 401-406. In the first adjustment procedure, the ending portion of the voting period is divided into multiple time segments of equal time length. According to some embodiments, the time length may be less than or equal to one day. For example, the time segments may all be one day long, several hours long, one hour long, thirty minutes long, ten minutes long, several minutes long, one minute long, etc.

In Step 401, the processor unit 2 of the computer node 10 determines cut-off vote numbers respectively for the multiple candidates by, with respect to each of the candidates, reading, from a storage region 11 that corresponds to the candidate among the storage regions 11 of the computer node 10, the vote number recorded by a data block 111 that was stored in the storage region 11 the latest during a previous time segment to serve as the cut-off vote number that corresponds to the candidate. The previous time segment is one of the time segments that is immediately before a current time segment during which the piece of vote data was obtained.

In Step 402, the processor unit 2 of the computer node 10 determines whether the cut-off vote number for the target candidate is the largest among the cut-off vote numbers for the multiple candidates. If so, the process goes to Step 403; otherwise, the process goes to Step 404.

In Step 403, the processor unit 2 of the computer node 10 maintains the number of newly-added votes associated with the target candidate.

In Step 404, the processor unit 2 of the computer node 10 determines a temporal vote number and a threshold vote number. Specifically, the processor unit 2 reads, from the matching storage region 11, the vote number (also referred to as “current vote number” hereinafter) recorded by the latest data block in the matching storage region 11, and computes the temporal vote number based on the current vote number and the number of newly-added votes. Furthermore, the processor unit 2 reads, from one of the storage regions 11 that corresponds to one of the candidates, to which one of the cut-off vote numbers that exceeds and is closest to the cut-off vote number corresponding to the target candidate corresponds, the vote number recorded by the latest data block stored therein to serve as the threshold vote number. In some embodiments, the temporal vote number is a sum of the current vote number and the number of newly-added votes.

In Step 405, the processor unit 2 of the computer node 10 determines whether the threshold vote number exceeds the temporal vote number. If so, the process goes to Step 403; otherwise, the process goes to Step 406.

In Step 406, the processor unit 2 of the computer node 10 adjusts the number of newly-added votes associated with the target candidate to be no larger than the threshold vote number minus the current vote number. Specifically, the processor unit 2 calculates a difference number by subtracting the current vote number from the threshold vote number, and adjusts the number of newly-added votes associated with the target candidate based on the difference number. In an embodiment, the number of newly-added votes associated with the target candidate is adjusted to be equal to the difference number when the difference number exceeds zero, and is adjusted to be equal to zero otherwise. In another embodiment, the number of newly-added votes associated with the target candidate is adjusted to be equal to the difference number minus one when the difference number exceeds zero, and is adjusted to be equal to zero otherwise. In this way, the first adjustment procedure suppresses an ability of the suspicious vote to elevate a rank of the target candidate among the multiple candidates that was determined during the previous time segment.

It is noted that the first adjustment procedure may be altered without departing from the purpose of suppressing suspicious vote of the disclosure. For example, according to some embodiments, the processor unit 2 in Step 404 may readily use the one of the cut-off vote numbers that exceeds and is closest to the cut-off vote number corresponding to the target candidate to serve as the threshold vote number.

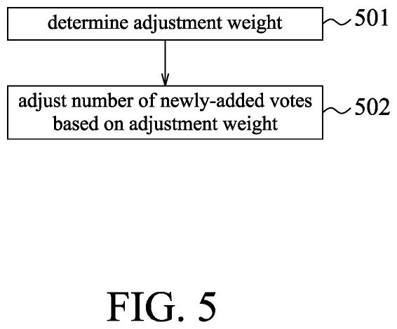

FIG. 5 exemplarily illustrates a second adjustment procedure that may be performed in Step 304 according to an embodiment of the disclosure. Referring to FIG. 5, the second adjustment procedure includes Steps 501 and 502. In the second adjustment procedure, the ending portion of the voting period is also divided into the multiple time segments of equal time length as described above with respect to the first adjustment procedure. The multiple time segments each correspond to an adjustment weight.

In Step 501, the processor unit 2 of the computer node 10 determines the adjustment weight that corresponds to the current time segment and that has a value less than one.

In an embodiment where the time length of the time segments is one day, the adjustment weight for the current time segment equals the first weight that is associated with a next date following the date on which the piece of vote data was obtained.

In some embodiments, the adjustment weights for the time segments are predetermined and recorded in a table that is accessible by the processor unit 2 (e.g., the table is stored in the storage module 1 of the computer node 10), so that the adjustment weight that corresponds to the current time segment may be determined based on the table.

In some embodiments, the adjustment weight that corresponds to the current time segment is determined by using a formula. For example, in an embodiment where the time length of the time segments is one day, a formula of (Wc+Wn)/2 is used, wherein Wa is the adjustment weight, We is the first weight associated with the date on which the piece of vote data was obtained, and Wn is the first weight associated with a next date following said date.

In some embodiments, the adjustment weight for the current time segment has a value that creates a weighting effect that is as if a different weight was used in place of the first weight in Step 301 for calculating the newly added votes. For example, in a case where the first weight used in Step 301 is 0.5 and where a desired new weight is 0.4, the adjustment weight is 0.8 that equals 0.4 divided by 0.5.

According to some embodiments, the adjustment weight may be negatively or positively correlated with a length of a remaining time period which starts from a time point when the piece of vote data was obtained and ends when the voting period ends. The adjustment weight being negatively correlated with the length of the remaining time provides a gentle way that lessens punishment to suspicious votes. On the contrary, the adjustment weight being positively correlated with the length of the remaining time provides a harsh way that reinforces punishment to suspicious votes.

In some embodiments, the adjustment weights for the time segments are of a fixed value which may be, for example, 0.4 or 0.5.

In Step 502, the processor unit 2 of the computer node 10 adjusts the number of newly-added votes associated with the one candidate to be equal to a product of the number of newly-added votes and the adjustment weight, rounded to an integer. According to some embodiments, the adjusted number of newly-added votes may be derived by rounding up, rounding down or rounding off the product.

The vote-inquiry procedure is to be performed by any of the computer nodes 10 when the computer node 10 obtains, during the voting period, a query request with respect to how many votes a candidate (also referred to as “requested candidate” hereinafter) among the multiple candidates has obtained. According to some embodiments, the computer node 10 may obtain the query request by generating the query request in response to an input by a user to the computer node 10, or by receiving the query request through the communication network 200 from a user terminal that is another computing device (e.g., a smart phone) which is operated by the user, which has a display screen, and which has access to the communication network 200. The query request indicates the requested candidate.

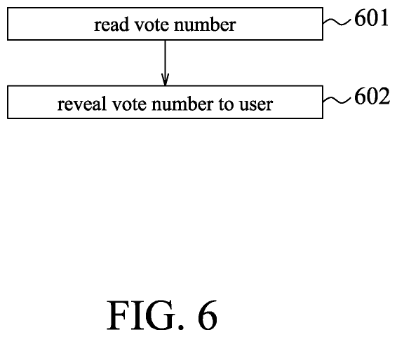

Referring to FIG. 6, the vote-inquiry procedure includes Steps 601 and 602.

In Step 601, the processor unit 2 of the computer node 10 reads, from the storage region 11 that corresponds to the requested candidate in the storage module 1 of the computer node 10, the vote number recorded by the latest data block in the storage region 11.

In Step 602, the processor unit 2 of the computer node 10 reveals the vote number thus read to the user by controlling the display of the computer node 10 to display the vote number in a case where the query request is generated by the computer node 10, or sending the vote number to the user terminal so that the vote number may be displayed on the display screen of the user terminal in a case where the query request is received from the user terminal.

According to some embodiments, the query request may indicate more than one candidate among the multiple candidates to inquire how many votes each of the more than one candidate has obtained. That is, the query request may relate to plural requested candidates. In these embodiments, the processor unit 2 in Step 601 may read, from the storage regions 11 that respectively correspond to the plural requested candidates in the storage module 1 of the computer node 10, the vote numbers that are respectively recorded by the latest data blocks respectively in the storage regions 11 and that are respectively associated with the plural requested candidates. Furthermore, the processor unit 2 in Step 602 may simultaneously reveal the vote numbers respectively associated with the plural requested candidates to the user by means of the display of the computer node 10 or the display screen of the user terminal.

It can be appreciated that by utilizing the blockchain technology in recording votes, safety and impartiality of the disclosed method and system for vote counting is increased. In addition, by utilizing the first weight that is associated with the voting date in computing the newly-added votes, early participation in the voting event is encouraged, thereby increasing participation rate of the voting event. Furthermore, by performing the adjustment procedure with respect to suspicious votes received during the ending portion of the voting period, impartiality may be further increased while maintaining the rights and interests of all voters (including voters casting the suspicious votes).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A digital-currency-based method for vote counting that is to be implemented by a vote counting system which includes multiple computer nodes in order to count, with respect to each of multiple candidates, a number of votes which are cast for the candidate during a voting period, the multiple computer nodes being in communication with one another and each including a storage module in which multiple storage regions corresponding respectively to the multiple candidates are allocated, each of the storage regions storing at least one data block each of which is encrypted and records a currency amount, a vote number and a voter identifier, one of the at least one data block that was last stored into the storage region serving as a latest data block in the storage region, the method comprising a vote-counting procedure that is to be performed by one computer node of the multiple computer nodes when the one computer node obtains, during the voting period, a piece of vote data that indicates an amount in a digital currency, one candidate of the multiple candidates, and a voter identifier, the vote-counting procedure including steps of:
A) by the one computer node, computing a number of newly-added votes associated with the one candidate based at least on the amount in the digital currency that is indicated by the piece of vote data and a first weight that is associated with a date on which the piece of vote data was obtained;
B) by the one computer node, determining whether the piece of vote data was obtained during an ending portion of the voting period;
C) by the one computer node when it is determined that the piece of vote data was obtained during the ending portion, determining whether the voter identifier indicated by the piece of vote data has been recorded in at least a number N of data blocks stored in one storage region that corresponds to the one candidate among the storage regions of the one computer node, wherein N is a positive integer;
D) by the one computer node when it is determined that the voter identifier has been recorded in at least the number N of data blocks, performing an adjustment procedure to adjust the number of newly-added votes;
E) by the one computer node, reading, from the one storage region, the vote number recorded by the latest data block in the one storage region, and computing a total number of votes associated with the one candidate based on the vote number thus read and the number of newly-added votes, wherein when it is determined that the piece of vote data was obtained during the ending portion and when it is determined that the voter identifier has been recorded in at least the number N of data blocks, the number of newly-added votes adjusted in step D) is used to compute the total number of votes;
F) by the one computer node after step E), generating a data block based at least on the amount in the digital currency and the voter identifier that are indicated by the piece of vote data and further on the total number of votes, wherein the data block thus generated includes currency amount information indicating a currency amount equal to the amount in the digital currency, vote number information indicating a vote number equal to the total number of votes, and the voter identifier;
G) by the one computer node after step F), encrypting the data block thus generated, and storing the data block into the one storage region; and
H) by the one computer node after step G) , sending the data block thus encrypted to the other computer nodes of the multiple computer nodes of the vote counting system, so that each of the other computer nodes verifies the data block in response to receiving the data block, and stores the data block into one of the storage regions thereof that corresponds to the one candidate after successfully verifying the data block.

2. The method of claim 1, wherein:
the first weight is positively correlated with a number of days from the date on which the piece of vote data was obtained till a deadline of the voting period;
the piece of vote data further indicates an influence attribute related to a voter; and
step A) is to compute the number of newly-added votes further based on a second weight that is associated with the influence attribute indicated by the piece of vote data, so that the number of newly-added votes is positively correlated with a rank that is related to the influence attribute.

3. The method of claim 1, wherein the ending portion of the voting period is divided into multiple time segments that are of equal time length and that include a current time segment during which the piece of vote data was obtained and a previous time segment immediately before the current time segment, and the adjustment procedure includes steps of:
determining cut-off vote numbers respectively for the multiple candidates by, with respect to each of the candidates, reading, from a storage region that corresponds to the candidate among the storage regions of the one computer node, the vote number recorded by a data block that was stored in the storage region during the previous time segment the latest to serve as the cut-off vote number that corresponds to the candidate;
determining whether the cut-off vote number for the one candidate is the largest among the cut-off vote numbers for the multiple candidates;
when it is determined that the cut-off vote number for the one candidate is the largest among the cut-off vote numbers for the multiple candidates, maintaining the number of newly-added votes associated with the one candidate; and
when it is determined that the cut-off vote number for the one candidate is not the largest among the cut-off vote numbers for the multiple candidates,
determining a temporal vote number and a threshold vote number, wherein the temporal vote number is determined by reading, from the one storage region, the vote number recorded by the latest data block in the one storage region to serve as a current vote number, and computing the temporal vote number based on the current vote number and the number of newly-added votes, and wherein the threshold vote number is determined by reading, from another storage region that corresponds to another one of the candidates among the storage regions, to which one of the cut-off vote numbers that exceeds and is closest to the cut-off vote number corresponding to the one candidate corresponds, the vote number recorded by the latest data block in the another storage region to serve as the threshold vote number,
determining whether the threshold vote number exceeds the temporal vote number,
when it is determined that the threshold vote number exceeds the temporal vote number, maintaining the number of newly-added votes associated with the one candidate, and
when it is determined that the threshold vote number does not exceed the temporal vote number, adjusting the number of newly-added votes associated with the one candidate to be no larger than the threshold vote number minus the current vote number.

4. The method of claim 3, wherein adjusting the number of newly-added votes is to:
calculate a difference number by subtracting the current vote number from the threshold vote number;
adjust the number of newly-added votes associated with the one candidate to be no larger than the difference number when the difference number exceeds zero; and
adjust the number of newly-added votes associated with the one candidate to be equal to zero when the difference number does not exceed zero.

5. The method of claim 1, wherein the ending portion of the voting period is divided into multiple time segments that are of equal time length, that each correspond to an adjustment weight, and that include a current time segment during which the piece of vote data was obtained, and the adjustment procedure includes steps of:
determining the adjustment weight that corresponds to the current time segment; and
adjusting the number of newly-added votes associated with the one candidate to be equal to a rounded up number of a product of the number of newly-added votes and the adjustment weight.

6. The method of claim 5, wherein the time length of the time segments is one day, and the adjustment weight for the current time segment equals the first weight that is associated with a next date following the date on which the piece of vote data was obtained.

7. The method of claim 5, wherein the adjustment weights for the time segments are of a same value.

8. The method of claim 5, wherein the adjustment weight is negatively correlated with a length of a remaining time period which starts from a time point when the piece of vote data was obtained and ends when the voting period ends.

9. The method of claim 1, further comprising a vote-inquiry procedure that is to be performed when the one computer node obtains, from a user terminal in communication with the computer node, a query request with respect to how many votes a requested candidate among the multiple candidates has obtained, the vote-inquiry procedure including steps of:
I) by the one computer node, reading, from a requested storage region that corresponds to the requested candidate among the storage regions of the one computer node, the vote number recorded by the latest data block in the requested storage region; and
J) by the one computer node after step I), revealing the vote number read in step I) by sending the vote number to the user terminal.

10. The method of claim 1, wherein step F) is to generate the data block further based on the date on which the piece of vote data was obtained and a time point at which the piece of vote data was obtained, so that the data block thus generated further includes date and time information that is indicative of when the piece of vote data was obtained.

11. A vote counting system for counting, with respect to each of multiple candidates, a number of votes which are cast for the candidate during a voting period based on a digital currency and on a blockchain structure, the system comprising:
multiple computer nodes that are in communication with one another through a communication network, wherein each of said computer nodes includes:
a communication module configured to connect with the communication network;
a storage module in which multiple storage regions that correspond respectively to the multiple candidates are allocated, wherein each of the storage regions stores at least one data block each of which is encrypted and records a currency amount, a vote number and a voter identifier, and one of the at least one data block that was last stored into the storage region serves as a latest data block in the storage region; and
a processor unit that is electrically connected to said communication module and said storage module and that is configured to, when obtaining, during the voting period, a piece of vote data that indicates an amount in a digital currency, one candidate of the multiple candidates, and a voter identifier,
compute a number of newly-added votes associated with the one candidate based at least on the amount in the digital currency that is indicated by the piece of vote data and a first weight that is associated with a date on which the piece of vote data was obtained,
determine whether the piece of vote data was obtained during an ending portion of the voting period,
when it is determined that the piece of vote data was obtained during the ending portion, determining whether the voter identifier indicated by the piece of vote data has been recorded in at least a number N of data blocks stored in one storage region that corresponds to the one candidate among the storage regions of said computer node, wherein N is a positive integer,
when it is determined that the voter identifier has been recorded in at least the number N of data blocks, performing an adjustment procedure to adjust the number of newly-added votes,
read, from the one storage region, the vote number recorded by the latest data block in said one storage region,
compute a total number of votes associated with the one candidate based on the number of newly-added votes thus computed and the vote number thus read, wherein when it is determined that the piece of vote data was obtained during the ending portion and when it is determined that the voter identifier has been recorded in at least the number N of data blocks, the number of newly-added votes thus adjusted is used to compute the total number of votes,
generate a data block based at least on the amount in the digital currency and the voter identifier that are indicated by the piece of vote data and further on the total number of votes thus computed, wherein the data block thus generated includes currency amount information indicating a currency amount equal to the amount in the digital currency, vote number information indicating a vote number equal to the total number of votes, and the voter identifier,
encrypt the data block thus generated,
store the data block thus encrypted into the one storage region, and
send the data block thus encrypted to the other computer nodes of said multiple computer nodes of the vote counting system, so that each of said other computer nodes verifies the data block in response to receiving the data block, and stores the data block into one of the storage regions thereof that corresponds to the one candidate after successfully verifying the data block.

12. The system of claim 11, wherein:
the first weight is positively correlated with a number of days from the date on which the piece of vote data was obtained till a deadline of the voting period;
the piece of vote data further indicates an influence attribute related to a voter; and
said processor unit is configured to compute the number of newly-added votes further based on a second weight that is associated with the influence attribute indicated by the piece of vote data, so that the number of newly-added votes is positively correlated with a rank that is related to the influence attribute.

13. The system of claim 11, wherein the ending portion of the voting period being divided into multiple time segments that are of equal time length and that include a current time segment during which the piece of vote data was obtained and a previous time segment immediately before the current time segment, and said processor unit of each of said computer nodes is configured to:
determine cut-off vote numbers respectively for the multiple candidates by, with respect to each of the candidates, reading, from a storage region that corresponds to the candidate among the storage regions of said computer node, the vote number recorded by a data block that was stored in the storage region during the previous time segment the latest to serve as the cut-off vote number corresponding to the candidate;
determine whether the cut-off vote number for the one candidate is the largest among the cut-off vote numbers for the multiple candidates;
when it is determined that the cut-off vote number for the one candidate is the largest among the cut-off vote numbers for the multiple candidates, maintain the number of newly-added votes associated with the one candidate; and
when it is determined that the cut-off vote number for the one candidate is not largest among the cut-off vote numbers for the multiple candidates,
determine a temporal vote number and a threshold vote number, wherein the temporal vote number is determined by reading, from the one storage region, the vote number recorded by the latest data block in the one storage region to serve as a current vote number, and computing the temporal vote number based on the current vote number and the number of newly-added votes, and wherein the threshold vote number is determined by reading, from another storage region among said storage regions that corresponds to another one of the candidates, to which one of the cut-off vote numbers that exceeds and is closest to the cut-off vote number corresponding to the one candidate corresponds, the vote number recorded by the latest data block in the another storage region to serve as the threshold vote number,
determine whether the threshold vote number exceeds the temporal vote number,
when it is determined that the threshold vote number exceeds the temporal vote number, maintain the number of newly-added votes associated with the one candidate, and
when it is determined that the threshold vote number does not exceed the temporal vote number, adjust the number of newly-added votes associated with the one candidate to be no larger than the threshold vote number minus the current vote number.

14. The system of claim 13, wherein said processor unit is configured to adjust the number of newly-added votes by:
calculating a difference number by subtracting the current vote number from the threshold vote number;
adjusting the number of newly-added votes associated with the one candidate to be no larger than the difference number when the difference number exceeds zero; and
adjusting the number of newly-added votes associated with the one candidate to be equal to zero when the difference number does not exceed zero.

15. The system of claim 11, wherein the ending portion of the voting period is divided into multiple time segments that are of equal time length, that each correspond to an adjustment weight, and that include a current time segment during which the piece of vote data was obtained, and said processor unit is configured to:
determine the adjustment weight that corresponds to the current time segment; and
adjust the number of newly-added votes associated with the one candidate to be equal to a rounded up number of a product of the number of newly-added votes and the adjustment weight.

16. The system of claim 15, wherein the time length of the time segments is one day, and the adjustment weight for the current time segment equals the first weight that is associated with a next date following the date on which the piece of vote data was obtained.

17. The system of claim 15, wherein the adjustment weights for the time segments are of a same value.

18. The system of claim 15, wherein the adjustment weight is negatively correlated with a length of a remaining time period which starts from a time point when the piece of vote data was obtained and ends when the voting period ends.

19. The system of claim 11, wherein said processor unit is further configured to, when obtaining, from a user terminal that is in connection with the communication network, a query request with respect to how many votes a requested candidate among the multiple candidates has obtained,
read, from a requested storage region that corresponds to the requested candidate among the storage regions, the vote number recorded by the latest data block in the requested storage region; and
reveal the vote number thus read by sending the vote number to the user terminal.

20. The system of claim 11, wherein said processor unit is configured to generate the data block further based on the date on which the piece of vote data was obtained and a time point at which the piece of vote data was obtained, so that the data block thus generated further includes date and time information that is indicative of when the piece of vote data was obtained.
